(19) United States
(12) Patent Application Publication
(10) Pub. No.: US 2014/0306359 A1
(43) Pub. Date: Oct. 16, 2014

(54) Simplified Fuel Cell Humidifier Design

(71) Applicant: GM GLOBAL TECHNOLOGY OPERATIONS LLC, Detroit, MI (US)

(72) Inventor: William L. Martz, Victor, NY (US)

(73) Assignee: GM Global Technology Operations LLC, Detroit, MI (US)

(21) Appl. No.: 13/862,872

(22) Filed: Apr. 15, 2013

(51) Int. Cl. H01M 8/04

(52) U.S. Cl. CPC H01M 8/04149
USPC 261/101; 29/890.07

(57) ABSTRACT

A fuel cell humidifier with a pleated separation layer between a wet side and a dry side is provided. The fuel cell humidifier includes an enclosure having a first inlet, first outlet, and a first gas flow region that allow flow of a first gas through the humidifier. The fuel cell humidifier also includes a second inlet and second outlet, and a second gas flow region that allow flow of a second gas through the humidifier. Characteristically, the first gas has a higher relative humidity than the second gas. A pleated diffusion medium separates the first flow region and the second flow region such that water from the first gas flows to the second gas thereby increasing the relative humidity of the second gas.

### TECHNICAL FIELD

The invention relates to fuel cells and, more particularly to, humidification of fuel cells.

### BACKGROUND

Fuel cells are used as an electrical power source in many applications. In particular, fuel cells are proposed for use in automobiles to replace internal combustion engines. A commonly used fuel cell design uses a solid polymer electrolyte (“SPE”) membrane or proton exchange membrane (“PEM”) to provide ion transport between the anode and cathode.

In proton exchange membrane type fuel cells, hydrogen is supplied to the anode as fuel and oxygen is supplied to the cathode as the oxidant. The oxygen can either be in pure form (O₂) or air (a mixture of O₂ and N₂). PEM fuel cells typically have a membrane electrode assembly (“MEA”) in which a solid polymer membrane has an anode catalyst on one face, and a cathode catalyst on the opposite face. The anode and cathode layers of a typical PEM fuel cell are formed of porous conductive materials, such as woven graphite, graphitized sheets, or carbon paper to enable the fuel to disperse over the surface of the membrane facing the fuel supply electrode. Each electrode has finely divided catalyst particles (for example, platinum particles), supported on carbon particles, to promote oxidation of hydrogen at the anode and reduction of oxygen at the cathode. Protons flow from the anode through the ionically conductive polymer membrane to the cathode where they combine with oxygen to form water, which is discharged from the cell. The MEA is sandwiched between a pair of porous gas diffusion layers (“GDL”), which in turn are sandwiched between a pair of non-porous, electrically conductive elements or plates. The plates function as current collectors for the anode and the cathode, and contain appropriate channels and openings formed therein for distributing the fuel cell's gaseous reactants over the surface of respective anode and cathode catalysts. In order to produce electricity efficiently, the polymer electrolyte membrane of a PEM fuel cell must be thin, chemically stable, proton transmissive, non-electrically conductive and gas impermeable. In typical applications, fuel cells are provided in arrays of many individual fuel cell stacks in order to provide high levels of electrical power.

The internal membranes used in fuel cells are typically maintained in a moist condition. This helps avoid damage to, or a shortened life of, the membranes, as well as to maintain the desired efficiency of operation. For example, lower water content of the membrane leads to a higher proton conduction resistance, thus resulting in a higher ohmic voltage loss. The humidification of the feed gases, in particular the cathode inlet, is desirable in order to maintain sufficient water content in the membrane, especially in the inlet region. Humidification in a fuel cell is discussed in commonly owned U.S. patent application Ser. No. 10/797,671 to Goebel et al.; commonly owned U.S. patent application Ser. No. 10/912,298 to Sennoun et al.; and commonly owned U.S. patent application Ser. No. 11/087,911 to Forte, each of which is hereby incorporated herein by reference in its entirety.

To maintain a desired moisture level, an air humidifier is frequently used to humidify the air stream used in the fuel cell. The air humidifier normally consists of a round or box type air humidification module that is installed into a housing of the air humidifier. Examples of this type of air humidifier are shown and described in U.S. patent application Ser. No. 10/516,483 to Tanihara et al., and U.S. Pat. No. 6,471,195, each of which is hereby incorporated herein by reference in its entirety.

Membrane humidifiers have also been utilized to fulfill fuel cell humidification requirements. For the automotive fuel cell humidification application, such a membrane humidifier needs to be compact, exhibit low pressure drop, and have high performance characteristics.

Designing a membrane humidifier requires a balancing of mass transport resistance and pressure drop. To transport water from wet side to dry side through a membrane, water molecules must overcome some combination of the following resistances: convectional mass transport resistance in the wet and dry flow channels; diffusion transport resistance through the membrane; and diffusion transport resistance through the membrane support material. Compact and high performance membrane humidifiers typically require membrane materials with a high water transport rate (i.e. GPU in the range of 10,000-16,000). GPU or gas permeation unit is a partial pressure normalized flux where 1 GPU=10-6 cm³ (STP)/(cm² sec cm Hg). As a result, minimizing the transport resistance in the wet and dry flow channels and the membrane support material becomes a focus of design.

Accordingly, there is a need for improved materials and methodologies for humidifying fuel cells.

### SUMMARY

In at least one aspect, the present invention solves one or more problems of the prior art by providing a fuel cell humidifier assembly with a pleated separator between a wet side and a dry side. The fuel cell humidifier assembly includes an enclosure having a first inlet, first outlet, and a first gas flow region that allow flow of a first gas through the humidifier. The enclosure also has a second inlet and second outlet, and a second gas flow region that allow flow of a second gas through the humidifier. Characteristically, the first gas has a higher relative humidity than the second gas. A pleated separator separates the first flow region and the second flow region such that water from the first gas flows to the second gas thereby increasing the relative humidity of the second gas.

In another embodiment, a fuel cell humidifier assembly is provided. The fuel cell humidifier assembly includes an enclosure having a first inlet, first outlet, and a first gas flow region allowing flow of a first gas through the humidifier. The enclosure also has a second inlet and second outlet, and a second gas flow region allowing a second gas to flow through the humidifier. Characteristically, the first gas has a higher relative humidity than the second gas. The fuel cell humidifier also includes a pleated separator that separates the first flow region and the second flow region. The pleated separator includes a diffusion medium sheet and a water transfer layer disposed over the diffusion medium sheet such that water from the first gas flows to the second gas thereby increasing the relative humidity of the second gas. The pleated separator further includes a plurality of ribs disposed thereon.

In another embodiment, a method for making the fuel cell humidifier set forth above is provided. The method includes a step of adhering a water transfer layer onto a diffusion medium sheet to form a water transfer layer-diffusion medium sheet combination. End seal beads are applied to the water transfer layer-diffusion medium sheet combination. The water transfer layer-diffusion medium sheet combination is folded to form a pleated separator with the end seal bead joining to form end seals. The pleated separator defines a first set of flow channels in the first flow region and a second set of flow channels in the second flow region. The pleated separator is typically placed within an enclosure having a first inlet, first outlet, and a first gas flow region that allows flow of a first gas through the humidifier. The enclosure also includes a second inlet and second outlet, and a second gas flow region that allow flow of a second gas through the humidifier.

### BRIEF DESCRIPTION OF THE DRAWINGS

Exemplary embodiments of the present invention will become more fully understood from the detailed description and the accompanying drawings, wherein:

FIG. 1 provides a schematic of a fuel cell system including a membrane humidifier assembly for humidifying a cathode inlet airflow to a fuel cell stack;

FIG. 2 provides a perspective view of a fuel cell humidifier;

FIG. 3 provides a perspective view of a separator used in the fuel cell humidifier of FIG. 2;

FIG. 4 provides a cross section of a separator used in the fuel cell humidifier of FIG. 2;

FIGS. 5A, 5B, and 5C provide a schematic flowchart of a method for forming the fuel cell humidifier of FIGS. 2-4;

FIG. 6 provides a schematic illustration of an apparatus for forming the fuel cell humidifier; and

FIG. 7 provides a schematic illustration showing the inclusion of a support frame for the pleated separator.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

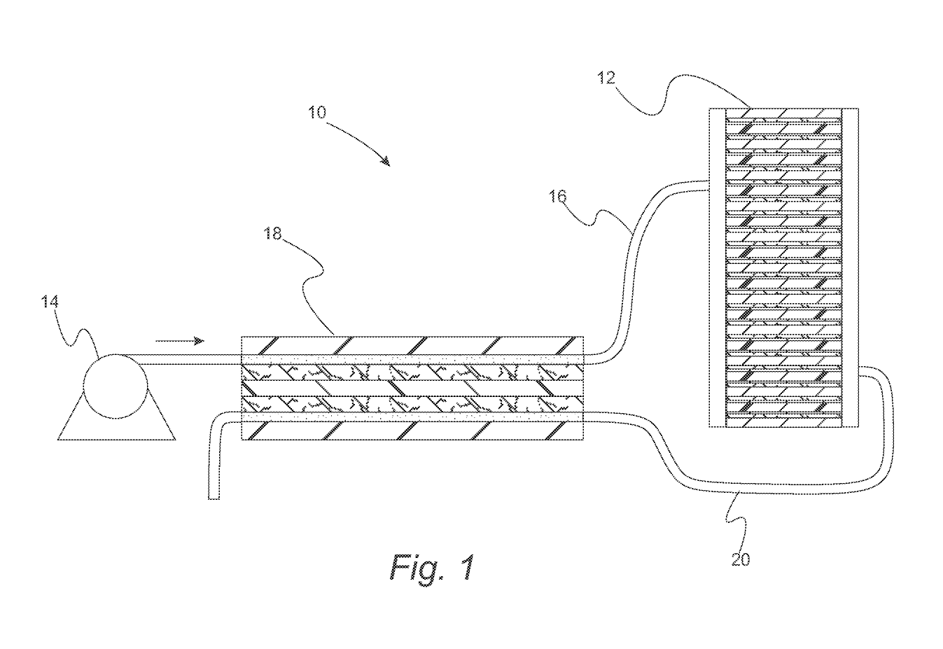

With reference to FIG. 1, a schematic of a fuel cell system incorporating a membrane humidifier assembly is provided. Fuel cell system 10 includes fuel cell stack 12. Compressor 14 provides a flow of air to the cathode side of the fuel cell stack 12 on a cathode input line 16. The flow of air from the compressor 14 is sent through membrane humidifier assembly 18 to be humidified. A cathode exhaust gas is output from the fuel cell stack 12 on a cathode output line 20. The cathode exhaust gas includes a considerable amount of water vapor and/or liquid water as a by-product of the electrochemical process in the fuel cell stack 12. As is well understood in the art, the cathode exhaust gas can be sent to membrane humidifier assembly 18 to provide the humidification for the cathode inlet air on the line 16.

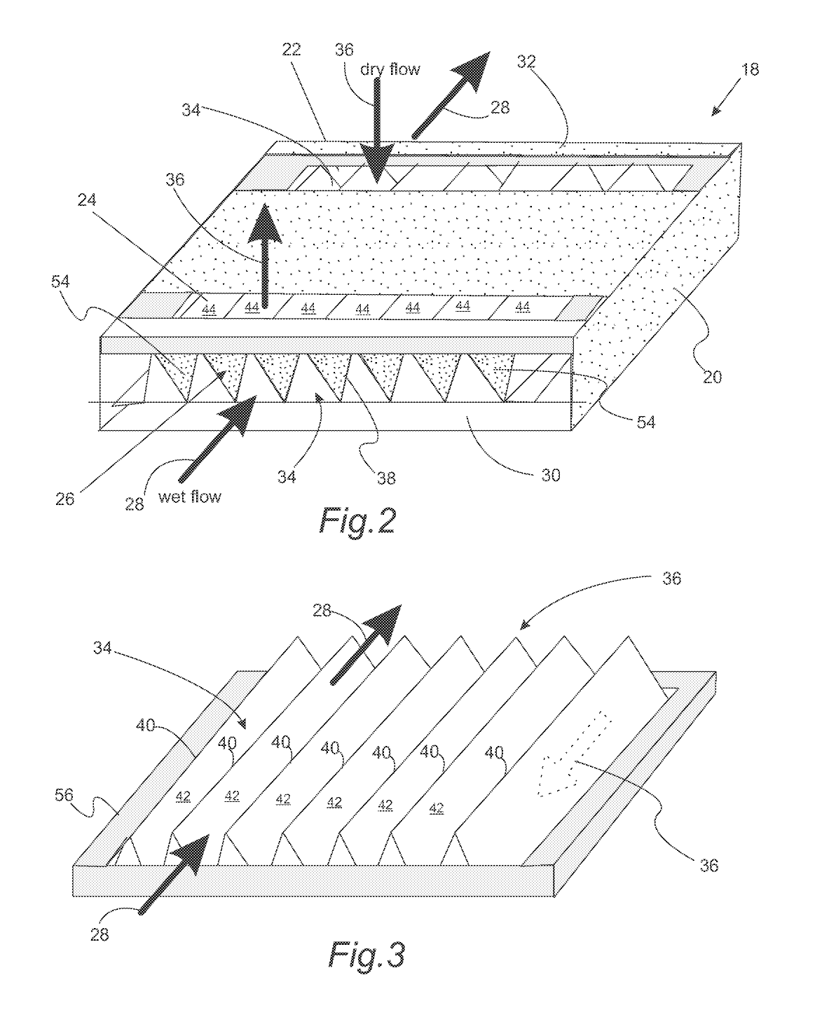

With reference to FIGS. 2, 3, and 4, schematic illustrations of a fuel cell humidifier assembly used in the fuel cell system of FIG. 1 are provided. In this embodiment, a pleated separation layer is positioned between a wet side and a dry side. Fuel cell humidifier assembly 18 includes enclosure 20 having a first inlet 22, first outlet 24, and first gas flow region 26 (wet side) that allow flow of a first gas through the humidifier as indicated by arrows 28. Fuel cell humidifier assembly 18 also includes a second inlet 30 and second outlet 32, and a second gas flow region 34 (dry side) that allow flow of a second gas through the humidifier as indicated by arrows 36. Characteristically, the first gas has a higher relative humidity (e.g., water content) than the second gas. Therefore, the first gas is referred to as a wet gas and the second gas is referred to as a dry gas. For fuel cell applications, the first and second gases are typically oxygen-containing gases such as air. Pleated separator 38 separates the first flow region 26 and the second flow region 34. Pleated separator 38 allows water to pass from the first gas to the second gas thereby increasing the relative humidity (e.g., water content) of the second gas. Pleated separator 38 includes diffusion medium 39 for this purpose.

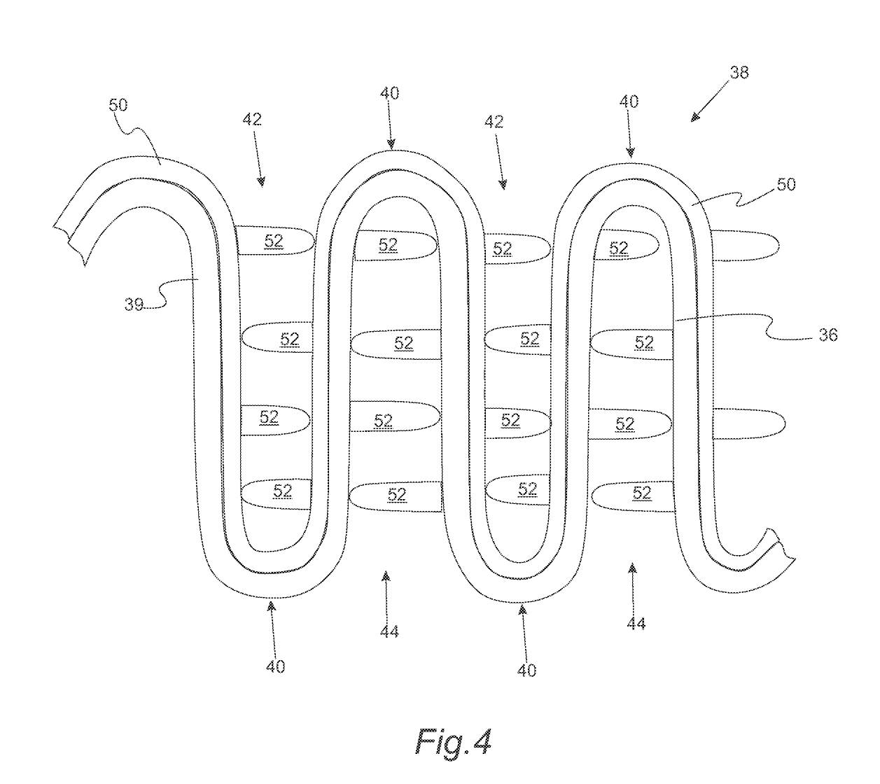

Still referring to FIGS. 2, 3, and 4, pleated separator 38 includes a plurality of folds 40 that define a first set of flow channels 42 in the first flow region 26 and a second set of flow channels 44 in the second flow region 34. In a refinement, the first set of flow channels 42 and the second set of flow channels 44 have a V-shaped or U-shaped cross section. In still another refinement, a water transfer layer 50 is disposed over the pleated diffusion medium 36 and contacts the second flow region. In a refinement, water transfer layer 50 includes an ionomeric membrane or a non-ionomeric membrane. Examples of suitable ionomers from which water transfer layer 50 may be constructed include, but are not limited to perfluorsulfonic acid polymers. In another refinement, pleated diffusion medium 36 includes a component selected from the group consisting of carbon paper, woven polymer mesh or porous spun-bound media made from aromatic polyester polymers such as liquid crystal polymers (LCP), polyphthalamides (PPA) and the like. In another refinement, pleated separator 38 includes a single assembly including the functions of diffusion medium and a water transfer layer. As depicted in FIG. 4, separator 38 includes ribs 52 that ensure the flow channels remain open for flow. In a refinement, ribs 52 include a water resistant cured resin with solid spacing particles (e.g., glass spheres) disposed therein. In another refinement, ribs 52 are embossed onto separator 38. End seals 54 are positioned at ends of the first set of flow channels and/or the second set of flow channels. In some refinements, potting rim 56 secures the separator in place. Examples of suitable materials for potting rim 56 include silicone or other water resistant rubber resins.

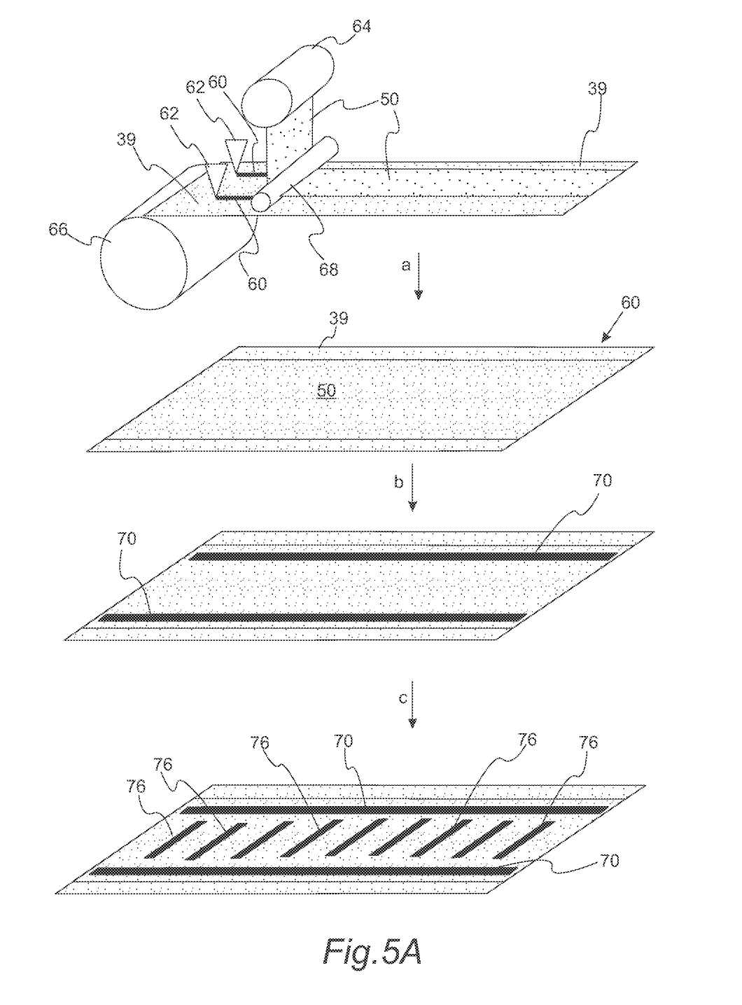

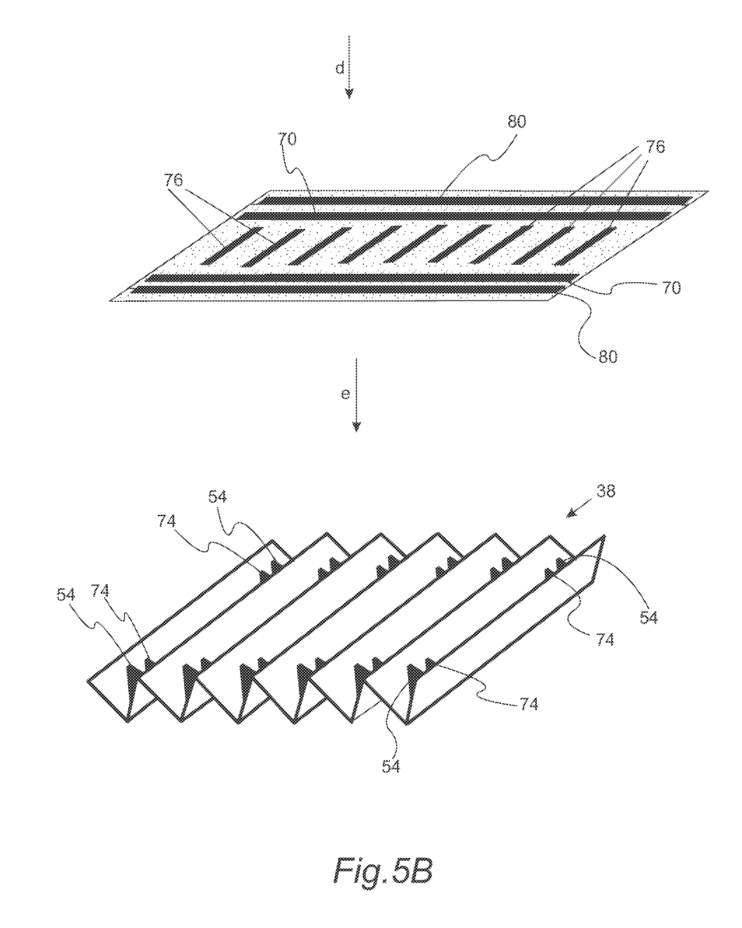

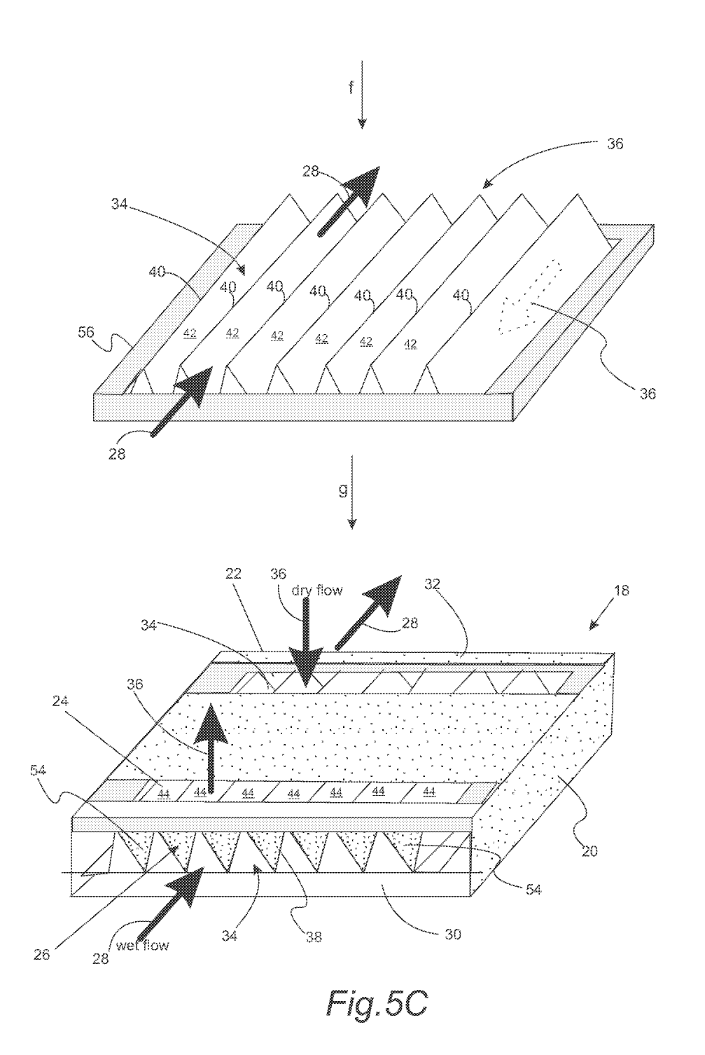

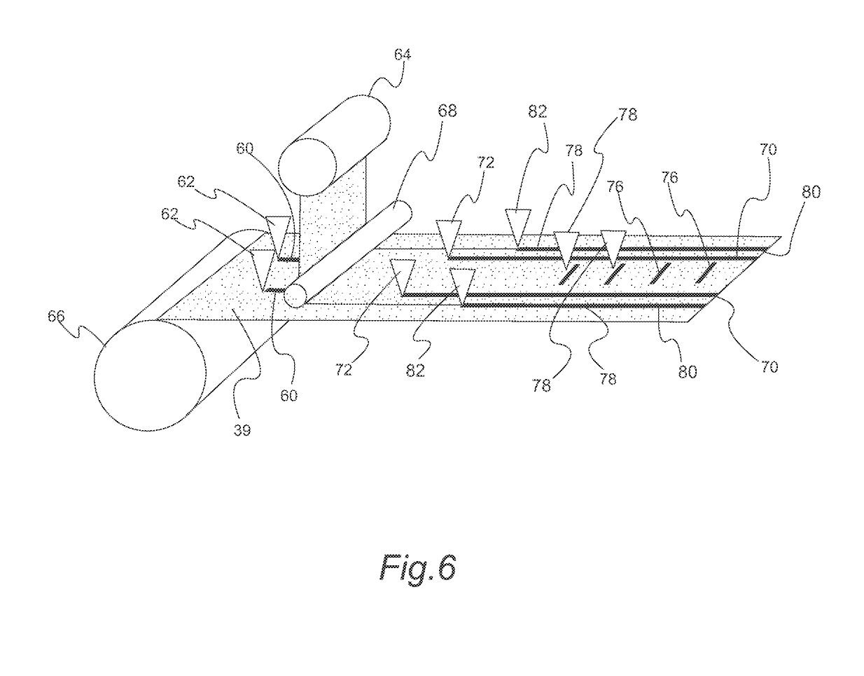

With reference to FIGS. 5A, 5B, 5C, and 6, schematics showing a method for the making the fuel cell humidifier separator set forth above are provided. FIGS. 5A, 5B, and 5C provide a schematic flowchart of the method while FIG. 6 provides a schematic illustration of an apparatus for forming the separator. In step a), water transfer layer 50 is adhered onto diffusion medium sheet 39 with adhesive 60 applied from applicator 62 to form a water transfer layer-diffusion medium sheet combination 60. Water transfer layer 50 is supplied from roll 64 while diffusion medium sheet 39 is supplied from roll 66 while idler 68 assists with the placement of water transfer layer 50 onto diffusion medium sheet 39. In step b), end seal beads 70 are applied from applicator 72 onto water diffusion layer 50. End seal beads 70 include an adhesive resin and optional solid spacer particles (e.g., glass spheres). End seal beads 70 form end seals 74 above when the water transfer layer-diffusion medium sheet combination 60 is folded. In step c), rib beads 76 are applied from applicators 78 to water transfer layer-diffusion medium sheet combination 60 to form ribs 52 (FIG. 4). In step d), end seal beads 80 are applied from applicator 82 at the end of water transfer layer 50 to form end seals 54 after folding. End seal beads 80 include an adhesive resin. In step e), water transfer layer-diffusion medium sheet combination 60 is folded to form separator 38 whereby a first set of flow channels in the first flow region and a second set of flow channels in the second flow region are formed as set forth above. In step f), potting rim 56 is applied around the periphery of separator 38. Finally, in step g) the separator is placed within enclosure 20.

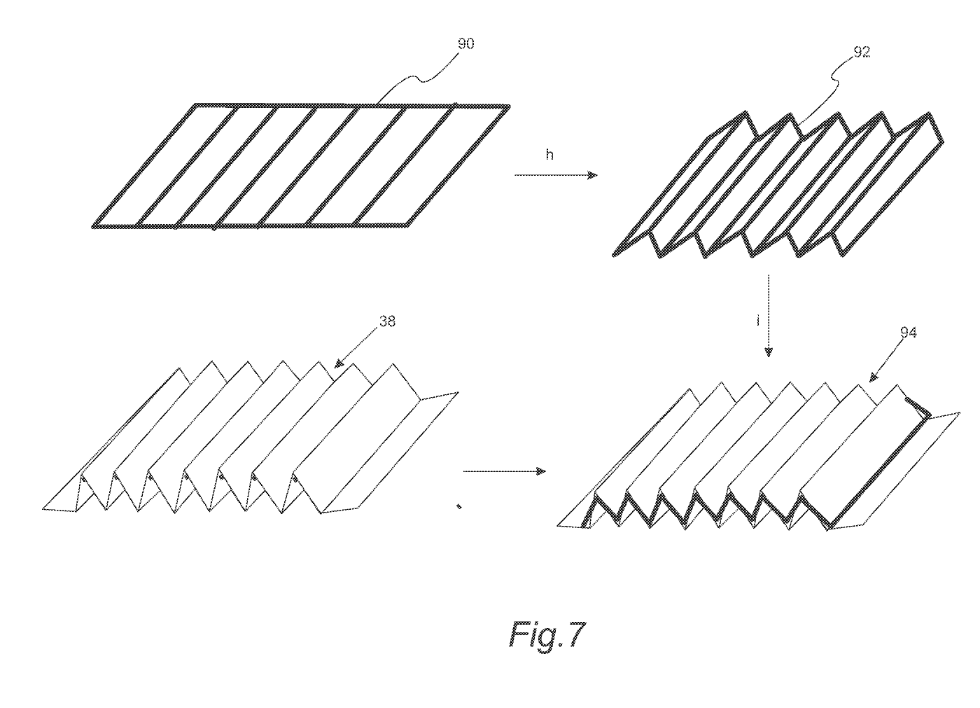

With reference to FIG. 7, a schematic illustration showing the inclusion of a support frame for the pleated separator is provided. In step h), support grid 90 is bent into support frame 92. Typically, support grid 90 and therefore support frame 92 are formed from a flexible metal such as aluminum. Separator 90 is then positioned onto support frame 92 to form support frame-separator combination 94.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A fuel cell humidifier assembly comprising:
an enclosure including a first inlet, first outlet, and a first gas flow region allowing flow of a first gas through the humidifier, the enclosure also includes a second inlet and second outlet, and a second gas flow region allowing a second gas to flow through the humidifier, the first gas having a higher relative humidity than the second gas; and
a pleated separator separating the first flow region and the second flow region, such that water from the first gas flows to the second gas thereby increasing the relative humidity of the second gas.

2. The fuel cell humidifier assembly of claim 1 wherein the pleated separator includes a plurality of folds that define a first set of flow channels in the first flow region, and a second set of flow channels in the second flow region.

3. The fuel cell humidifier assembly of claim 1 wherein flow channels of the first set of flow channels and the second set of flow channels are a V-shaped or U-shaped cross section.

4. The fuel cell humidifier assembly of claim 1 wherein the pleated separator includes a diffusion medium sheet.

5. The fuel cell humidifier assembly of claim 4 wherein the pleated separator further includes a water transfer layer disposed over the pleated diffusion medium sheet, the water transfer layer contacting the second flow region.

6. The fuel cell humidifier assembly of claim 5 wherein the water transfer layer includes an ionomeric membrane or a non-ionomeric membrane.

7. The fuel cell humidifier assembly of claim 6 wherein the water transfer layer includes a perfluorsulfonic acid polymer.

8. The fuel cell humidifier assembly of claim 4 wherein the diffusion medium sheet includes a component selected from the group consisting of carbon paper, woven polymer mesh or porous spun-bound media made from aromatic polyester polymers, and combinations thereof.

9. The fuel cell humidifier assembly of claim 1 wherein the pleated separator includes a single assembly including the functions of diffusion medium and a water transfer layer.

10. The fuel cell humidifier assembly of claim 1 wherein flow channels in the first set of flow channels and the second set of flow channels include ribs that ensure the flow channels remain open for flow.

11. The fuel cell humidifier assembly of claim 10 wherein the ribs include a cured resin with solid particles disposed therein.

12. The fuel cell humidifier assembly of claim 9 wherein the ribs are embossed in the pleated separator.

13. The fuel cell humidifier assembly of claim 1 further comprising end seal at ends of the first set of flow channels and the second set of flow channels.

14. The fuel cell humidifier assembly of claim 1 further comprising a potting rim securing the pleated diffusion medium.

15. The fuel cell humidifier assembly comprising:
an enclosure having a first inlet, first outlet, and a first gas flow region allowing flow of a first gas through the humidifier and a second inlet and second outlet, and a second gas flow region allowing a second gas to flow through the humidifier, the first gas having a higher relative humidity than the second gas; and
a pleated separator separating the first flow region and the second flow region, the pleated separator including a diffusion medium sheet and a water transfer layer disposed over the diffusion medium sheet such that water from the first gas flows to the second gas thereby increasing the relative humidity of the second gas, the pleated separator further including a plurality of ribs disposed thereon.

16. A method for making a fuel cell humidifier, the method comprising:
adhering a water transfer layer onto a diffusion medium sheet to form a water transfer layer-diffusion medium sheet combination;
applying end seal beads to the water transfer layer-diffusion medium sheet combination; and
folding the water transfer layer-diffusion medium sheet combination to form a pleated separator with the end seal bead joining to form end seals, the pleated separator defining a first set of flow channels in the first flow region, and a second set of flow channels in the second flow region.

17. The method of claim 16 further comprising applying a potting rim to the periphery of the pleated separator.

18. The method of claim 17 further comprising placing the pleated separator in an enclosure, the enclosure having a first inlet, first outlet, and a first gas flow region allowing flow of a first gas through the humidifier and a second inlet and second outlet, and a second gas flow region allowing a second gas to flow through the humidifier, the first gas having a higher relative humidity than the second gas.

19. The method of claim 17 further comprising applying a plurality of ribs to the water transfer layer, the plurality of ribs including a cured resin with solid particles disposed therein.

20. The method of claim 17 further comprising positioning the separator onto a support frame.
